(19) United States
(12) Patent Application Publication
(10) Pub. No.: US 2006/0050395 A1
(43) Pub. Date: Mar. 9, 2006

(54) Scattering coat

(75) Inventors: Bertrand Bertin Mourot, Paris (FR); Elisabeth Rouyer, Cheverny (FR); Laurent Joret, Chaville (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/518,531

(22) PCT Filed: Jul. 2, 2003
(86) PCT No.: PCT/FR03/02053

§ 371 Date: Jul. 21, 2005

(30) Foreign Application Priority Data
Jul. 3, 2002 (FR) 02/08289

(51) Int. Cl. G02B 5/02; G02B 13/20

(52) U.S. Cl. 359/599

(57) ABSTRACT

Diffusing layer based on mineral particles, intended to make a light source homogeneous, characterized in that it incorporates an electromagnetic insulating device whose resistance per square is greater than 100 Ω.

The invention relates to improvements made to a diffusing layer intended to be deposited on a substrate in order to make a light source homogeneous.

Although the invention is not limited to such applications, it will be described more particularly with reference to layers used to make the light emitted from a backlighting system homogeneous.

Such a system may in particular be a light source or backlight used especially as a backlighting source for liquid crystal screens. The invention may also be used when the light from architectural flat lamps used for example in ceilings, floors or walls needs to be made homogeneous. It can also be used in flat lamps for municipal applications such as lamps for advertising panels or lamps able to constitute the shelves or backs of display cabinets.

The light sources used in these backlighting systems are mainly discharge tubes or bulbs commonly known as CCFLs (Cold Cathode Fluorescent Lamps), HCFLs (Hot Cathode Fluorescent Lamps) or DBDFLs (Dielectric Barrier Discharge Fluorescent Lamps). All these systems have in common the fact that they are powered by a variable-voltage source the frequency of which is generally in the range from 10 to 100 kHz.

Now, in these frequency ranges, both in the transient switchon and switchoff phases and in the steady state phases, electromagnetic disturbances and/or phenomena of the accumulation of surface charges arise, generating disturbances in the liquid crystal cells.

In order to limit or even eliminate these phenomena it is known practice for insulation to be provided against the electromagnetic waves created by the backlighting system and for the surface charges to be removed to the ground potential of the screen module.

It will be recalled that a screen of this type incorporates, between the backlighting system (which constitutes the generator of electromagnetic interference) and the LCD (liquid crystal display) screen, a diffusing layer which, as its name suggests, ensures homogeneous diffusion of the light source coming from the backlighting systems.

In order to electromagnetically insulate such a screen, use is made, on this diffuser (which generally is made of plastic, for example of PMMA or of polycarbonate), of a sheet of thermoplastic (PET) which is itself covered with a layer of a conducting material, of the ITO (indium tin oxide) type, for example.

Other electromagnetic insulation techniques are known, but these are inappropriate to this type of application. In particular, the use of an array of conducting wires, or of a metal grating, a metal film, is impossible. This is because the diffusers incorporating this type of insulating device are unable to guarantee a light transmission T_{L} of at least 50% and a light absorption A_{L} of less than 15%, these two conditions being required by manufacturers of screens incorporating backlighting systems as described above.

In addition, the nature of the material of which the diffuser is made can be quoted by way of a drawback. We have seen that this diffuser was generally made of plastic. Now, such materials are sensitive to heat and, for large sized screens, measuring more than 10″ across the diagonal (the diagonal in this case being a characteristic dimension of the screen), the light sources are situated inside an enclosure as close as possible to the diffusing part (structure of the direct light type), and this is not generally the case of small-sized screens (measuring less than 10″ across the diameter) for which the light sources are positioned on the side of the enclosure (structure of the edge light type), the light being conveyed toward the diffusing layer by a waveguide, the release of heat being particularly appreciable.

For these large-sized screens, this release of heat generally leads to structural deformation of the diffusing part, which is embodied by heterogeneity of the brightness of the picture projected onto the screen.

Aside from these problems of mechanical integrity of the diffusing part, there is also the problem of the additional thickness of the latter due to the presence of the thermoplastic sheet provided with its electromagnetic insulating device which leads, on the one hand, to multiple reflections and, on the other hand, to additional cost at the time of assembly.

Now, the current desire which is tending toward reducing the size of screens in terms of their thickness and in terms of the number of components involved goes against this solution. Furthermore, this increase in thickness leads to a reduction in brightness of the projected picture.

The inventors have therefore set themselves the task of finding a means of obtaining an electromagnetic insulation for a large-sized screen (measuring more than 10″ across the diagonal) and which does not have the disadvantages of the aforementioned solutions, particularly in terms of the size and in terms of the loss of picture quality.

To this end, the diffusing layer based on mineral particles, intended to make a light source homogenous, is characterized, according to the invention, in that it incorporates an electromagnetic insulating device whose resistance per square is greater than 100 Ω.

In some preferred embodiments of the invention, recourse may possibly also be had to one and/or other of the following arrangements:
the resistance per square is between 300 and 700 Ω,
the insulating device consists of at least one layer that is translucent in the visible domain and made of electrically conducting material, said conducting layer being deposited as close as possible to the diffusing layer,
the conducting layer is based on translucent conducting oxide,
the diffusing layer is deposited on a substrate and the conducting layer is deposited on said diffusing layer,
the diffusing layer is combined with a substrate, the conducting layer being placed between the substrate and the diffusing layer,
the diffusing layer is combined with a substrate, the diffusing layer being deposited on one of the sides of the substrate, while the conducting layer is deposited on the opposite side of said substrate,
the insulating device is incorporated into the diffusing layer,
the diffusing layer is made of elements comprising particles and a binder, the binder allowing the particles to be agglomerated with one another, the insulating device consisting of one or other of said elements,
the particles are made of metal or metal oxides,
it contains particles of ZrO₂,
the particle size is between 50 nm and 1 μm,
the particles are based on F:SnO₂ or ITO
the binder is a mineral or organic electrically conducting binder,
the substrate is a glass substrate,
the substrate is a transparent substrate based on polymer, for example made of polycarbonate,
the diffusing layer incorporates a coating having a functionality other than that of insulating, particularly a coating with a low-emissivity function, antistatic function, antifogging function or an antifouling function.

According to another aspect of the invention, this invention targets the use of a diffusing layer as described hereinabove to produce a diffusing substrate in a backlighting system and/or flat lamp system.

In some preferred embodiments of the invention, recourse may possibly also be had to one and/or other of the following arrangements:
the substrate is one of the sheets of glass that make up the backlighting system and/or of a flat lamp,
the substrate has a characteristic dimension tailored to direct light applications,
the thickness and/or the cover density of the layer varies over the deposition surface,
the thickness of the diffusing layer is between 0.5 and 5 μm.

Other advantages and particulars of the invention will become apparent from reading the detailed description which will follow.

Thus, according to a first embodiment of the invention, the diffusing layer consists of particles agglomerated in a binder, said particles having a mean diameter of between 0.3 and 2 microns, said binder being in a proportion of between 10 and 40% by volume and the particles forming aggregates the dimension of which ranges between 0.5 and 5 microns, said layer having a contrast attenuation greater than 40% and preferably greater than 50%. This diffusing layer is particularly described in application WO 0190787.

The particles are chosen from semitransparent particles and preferably from mineral particles such as oxides, nitrides and carbides.

The particles will preferably be chosen from the oxides of silica, alumina, zirconia, titanium, cerium or a mixture of at least two of these oxides.

Such particles may be obtained by any means known to those skilled in the art particularly by precipitation or by pyrogenation. The particles have a particle size such that at least 50% of the particles deviate from the mean diameter by less than 50%.

The binder has sufficient temperature withstand to withstand the operating temperatures and/or the sealing temperature of the lamp if the layer is produced before the lamp is assembled and in particular before the latter is sealed.

When the layer is in an exterior position, the binder is also chosen to have enough resistance to abrasion that it can, without damage, undergo all the handling of the backlighting system, for example when mounting the flat screen.

Depending on the requirements, the binder may be chosen to be mineral, for example in order to encourage temperature resistance in the layer, or organic, particularly to simplify the production of said layer, it being possible for crosslinking to be obtained simply, for example in the cold state. The choice of a mineral binder whose temperature resistance is high will in particular make it possible to produce a backlighting system with a long life without any risk of any degradation of the layer occurring due, for example, to fluorescent tubes which produce considerable heating. Indeed it has been found that, with the known solutions, there is degradation of the plastic film with temperature and this therefore makes producing large-size backlighting systems an enormously tricky prospect.

The binder has an index different than that of the particles and the difference between these two indexes is preferably at least 0.1. The index of the particles is above 1.7 and that of the binder is preferably below 1.6.

The binder is chosen from the calcium silicates, sodium silicates, lithium silicates, aluminum phosphates, polymers of the polyvinyl alcohol type, thermosetting resins, acrylics, etc.

To encourage the formation of aggregates in the desired size, the invention anticipates the addition of at least one additive leading to a random distribution of the particles in the binder. As a preference, the additive or dispersant is chosen from the following: an acid, a base, or ionic polymers of low molecular mass, particularly of a mass less than 50 000 g/mol.

It is also possible to add other agents, for example a wetting agent such as nonionic, anionic or cationic surfactants, to form a layer which is homogeneous on a large scale.

It is also possible to add rheology modifiers such as cellulose ethers.

The layer thus defined may be deposited with a thickness of between 1 and 20 microns. The methods for depositing such a layer may be any means known to those skilled in the art such as depositing by screenprinting, coating with paint, dipcoating, spincoating, flowcoating, spraying, etc.

When the desired thickness of the deposited layer is greater than 2 microns, a deposition process of the screen-printing type is used.

When the thickness of the layer is less than 4 microns, deposition is preferably performed by flowcoating or by spraying.

Provision is also made for the production of a layer whose thickness varies according to the area of coverage on the surface; such an embodiment may allow intrinsic inhomogeneities in a light source to be corrected. For example, it is possible in this way to correct the variation in illumination of light sources along their length. According to another embodiment leading to practically the same effect of correcting for intrinsic inhomogeneities of light sources, provision is made for there to be a layer whose cover density varies over the deposition surface; this may, for example, be a coating deposited by screenprinting the density of spots of which varies from a completely covered region to a region of dispersed spots, the transition being gradual or otherwise.

According to another embodiment of the diffusing layer, provision is made for at least one of the elements, or even at least two of the elements that make up the diffusing layer to be electrically conducting. These may either be particles forming the aggregates or particles forming the binder.

In the case of an electrically conducting binder of SnO₂ mineral or organic type, provision is for example made for use to be made of a conducting polymer (polypyrrole) or nanoparticles (F:SnO₂, Sb:SnO₂, ITO).

When the particles that form the aggregates are electrically conducting, these may be based on transparent conducting oxide powder such as F:SnO₂, Sb:SnO₂, Sn:In₂O₃, Al:ZnO, for example.

According to yet another embodiment, the diffusing layer may be obtained from a substrate which has undergone a surface treatment. This may for example be a sand-blasted substrate, a substrate which has undergone an acid attack marketed by Saint Gobain Glass France under the name of “Satinovo”®, or alternatively a substrate coated with a coat of enamel marketed by Saint Gobain Glass France under the names “Emalit”® or “Opalit”®.

Regardless of the embodiment of the diffusing layer (except for the one obtained from intrinsically electrically conducting elements), this layer needs to be combined with a device that provides electromagnetic insulation and/or provides for the flow of surface charges.

This electromagnetic insulating device consists of at least one electrically conducting layer positioned as close as possible to the diffusing layer, this conducting layer being transparent in the visible domain (including having low or zero haze, in this case being translucent).

According to the invention, such conducting layers are deposited on transparent or semitransparent substrates having a flat or non-flat shape depending on the applications.

The conducting layer is made up of conducting transparent oxides (more commonly known as TCOs) such as, in particular, F:SnO₂, Sb:SnO₂, Sn:In₂O₃, Al:ZnO.

According to a first technique, this conducting layer can be produced using a reactive cathode sputtering process either from metal targets or from oxide targets.

According to a second technique, the conducting layer may be produced using a pyrolytic technique.

This may involve the pyrolysis of powder. This technique consists in using a jet of carrier gas to spray onto the surface of the substrate, a powder of organometallic precursors or a mixture of powders, the powder breaking down under the effect of the heat of the substrate, releasing the atoms that make up the conducting layer.

It may also involve the pyrolysis of liquid. According to this process, the chemical precursors, in the form of a liquid solution or suspension, are brought into contact with the substrate for example using a spraycoating technique or a dipcoating or spincoating technique.

The conducting layer may also be deposited on the substrate by chemical vapor deposition (CVD) or by plasma-enhanced CVD.

According to yet another technique, the conducting layer may be obtained by a sol-gel technique.

Whatever the method used to produce the conducting layer, the latter has a resistance per square of more than 100 Ω and preferably of between 300 and 700 Ω. This conducting layer constitutes an insulating device for frequencies of between 10 and 100 kHz; this conducting layer also makes it possible to produce a device for the flow of electrostatic or surface charges. (These resistance per square properties are also obtained by the intrinsically conducting diffusing layer described hereinabove).

This conducting layer is therefore associated with a diffusing layer, the whole being associated with a substrate, particularly one made of glass or of polymer (PMMA, polycarbonate).

This association with the substrate may be achieved in various ways:
the substrate is placed between the diffusing layer and the conducting layer,
the conducting layer covers one of the sides of the substrate, the diffusing layer for its part covering the conducting layer,
the diffusing layer covers one of the sides of the substrate, the conducting layer for its part covering the diffusing layer,
the diffusing layer comprising at least one electrically conducting element (binder and/or aggregate) is in contact with one of the sides of the substrate.

Whatever the configuration of the association formed by the substrate, the diffusing layer alone (intrinsically conducting), the diffusing layer associated with the conducting layer, the assembly has a light transmission T_{L} of at least 20%, and preferably of more than 50% and a light absorption A_{L} of less than 15%. The thickness of the diffusing layer thus formed is between 0.5 and 5 μm, of which 10 nm to 1 μm account for the single conducting layer. The light transmission value for the conducting layer alone is at least 80% and preferably above 85%.

An alternative form of embodiment which can be associated with the methods of producing diffusing layers having a shielding device described hereinabove, consists in incorporating into the assembly a coating which has another functionality. This may be a coating with a function of blocking out radiation with wavelengths in the infrared (using, for example, one or more layers of silver surrounded by layers of dielectric, or layers of nitride such as TiN or ZrN or of metal oxides or of steel or of Ni—Cr alloy) with a low emissivity function (for example using a doped metal oxide such as F:SnO₂ or tin-doped indium oxide ITO or one or more layers of silver), a heating layer (doped metal oxide, for example Cu, Ag) or an array of heating wires (copper wires or strips screen-printed from a conducting silver slurry), an antifogging function (using a hydrophilic layer) an antifouling function (photocatalytic coating containing TiO₂ at least partially crystallized in anotase form).

The applications for which the invention is intended are, in particular, backlighting systems for example used for backlighting liquid crystal display screens, or alternatively flat lamps used for architectural lighting or alternatively municipal lighting, or more generally in any system incorporating light sources likely to generate electromagnetic disturbances.

In the nonlimiting case of flat lamps, the assembly of layers (diffusing plus electrically conducting layers) is deposited on the sheet of glass that constitutes the front face of the lamp.

According to a first embodiment of a flat lamp that is to incorporate the diffusing layer according to the invention, the collection of layers (diffusing plus electrically conducting layers) is deposited on the side of the sheet of glass that faces toward the inside of the lamp; in such an embodiment, the collection of layers (diffusing plus electrically conducting layers) is to be deposited on a sheet of glass while the lamp is being produced. According to this embodiment, the collection of layers has to have enough temperature resistance to withstand the various heat treatments needed to produce such a lamp, particularly to carry out the deposition activities that correspond to the production of the electrodes and to seal around the periphery of the two sheets of glass that make up the structure of the flat lamp.

If spacers are needed, particularly to keep a uniform space between the two sheets of glass, the invention provides for the collection of layers (diffusing plus electrically conducting layers) to be deposited leaving free regions corresponding to the locations intended for the spacers so that the adhesion of these spacers is not disturbed by the layer according to the invention. Such free spaces may easily be obtained by choosing to deposit the layer using a screen-printing technique.

According to a second embodiment of a flat lamp incorporating the diffusing layer according to the invention, the layer (diffusing plus electrically conducting) is deposited on the side of the sheet of glass facing toward the outside of the lamp; according to this embodiment the collection of layers (diffusing plus electrically conducting layers) is chosen to have enhanced mechanical resistance properties, particularly enhanced resistance to abrasion.

According to yet another alternative form of embodiment regarding the use of the collection of improved diffusing layers according to the invention (diffusing plus electrically conducting layers) in the embodiment of a flat lamp and/or of a backlighting system, said layer (diffusing and electrically conducting) is deposited on a transparent or semitransparent substrate independent of the sheets of glass that make up the structure of the flat lamp or of the backlighting system. Such an embodiment may consist in depositing the collection of layers (diffusing plus electrically conducting layers) on a glass substrate held some distance away from the front face of the lamp or of the backlighting system; this embodiment makes it possible, according to the rules of physics, to further improve the diffusing effect of the collection of layers. In counterbalance, the volume or bulk of such an embodiment once again becomes equivalent to the solutions known in the prior art, but with diffusion and electromagnetic insulation performance that is far more durable over time.

Improved layers (diffusing and insulated) thus set out in accordance with the invention therefore make it possible to produce backlighting systems for example intended for illuminating liquid crystal display screens. By comparison with the solutions known in the prior art, the layer according to the invention makes it possible to reduce the bulk of said backlighting system for a given performance in terms of luminance, brightness and life.

1. A diffusing layer comprising a mineral particle layer and an electromagnetic insulating device with a resistance per square greater than 100 Ω.

2. The diffusing layer as claimed in claim 1, wherein the electromagnetic insulating device has a resistance per square between 300 and 700 Ω.

3. The diffusing layer as claimed in claim 1, wherein the electromagnetic insulating device consists of at least one electrically conducting layer that is translucent in the visible domain, said conducting layer being deposited as close as possible to the mineral particle layer.

4. The diffusing layer as claimed in claim 3, wherein the conducting layer comprises a transparent conducting oxide.

5. The diffusing layer as claimed in claim 1 wherein the mineral particle layer is deposited on a substrate and the conducting layer is deposited on said mineral particle layer.

6. The diffusing layer as claimed in claim 1 wherein the mineral particle layer is combined with a substrate, the conducting layer being placed between the substrate and the mineral particle layer.

7. The diffusing layer as claimed in claim 1 wherein the mineral particle layer is combined with a substrate, the mineral particle layer being deposited on one of the sides of said substrate, while the conducting layer is deposited on the opposite side of said substrate.

8. The diffusing layer as claimed in claim 1 wherein the electromagnetic insulating device is incorporated into the mineral particle layer.

9. The diffusing layer as claimed in claim 1 wherein the mineral particle layer further comprises a binder, the binder allowing the mineral particles to be agglomerated with one another.

10. The diffusing layer as claimed in claim 9, wherein the mineral particle comprises metal or metal oxides.

11. The diffusing layer as claimed in claim 9, wherein the mineral particle comprises ZrO₂.

12. The diffusing layer as claimed in claim 9 wherein the mineral particle size is between 50 nm and 1 μm.

13. The diffusing layer as claimed in claim 9 wherein the mineral particle comprises F:SnO₂ or ITO.

14. The diffusing layer as claimed in claim 9, wherein the binder is a mineral or an organic electrically conducting material.

15. The diffusing layer as claimed in claim 5 wherein the substrate is a glass substrate.

16. The diffusing layer as claimed in claim 5 wherein the substrate is a transparent substrate comprising a polymer.

17. The diffusing layer as claimed in claim 1 wherein the diffusing layer incorporates a coating having a functionality other than that of insulating, particularly a coating with a low-emissivity function, antistatic function, antifouling function or an antifouling function.

18. The diffusing layer as claimed in claim 1 wherein it has a light transmission T_{L} greater than 20% and preferably greater than 50%.

19. The diffusing layer as claimed in claim 1 wherein it has a thickness of between 0.5 and 5 μm.

20. A method for producing a diffusing substrate in a system provided with light sources comprising adding a diffusing layer as claimed in claim 1 to a diffusing substrate in a system provided with light sources.

21. A method for producing a diffusing substrate in a backlighting system comprising adding a diffusion layer as claimed in claim 1 to a diffusing substrate in a backlighting system.

22. The method as claimed in claim 21 wherein the diffusing substrate is a sheet of glass that comprises the backlighting system.

23. A method for producing a diffusing substrate in a flat lamp system comprising adding a diffusion layer as claimed in claim 1 to a diffusing substrate in a flat lamp system.

24. The method as claimed in claim 23 wherein the diffusing substrate is a sheet of glass that comprises the flat lamp system.

25. The method as claimed in claim 20 wherein the diffusing substrate has a characteristic dimension tailored to direct light applications.

26. The method as claimed in claim 20 wherein the thickness and/or the cover density of the diffusion layer varies over the deposition surface.

27. The diffusing layer as claimed in claim 4 wherein the transparent conducting oxide is selected from the group consisting of F:SnO₂, Sb:SnO₂, Sn:In₂O₃, Al:ZnO and mixtures thereof.

28. The diffusing layer as claimed in claim 6 wherein the substrate is a glass substrate.

29. The diffusing layer as claimed in claim 7 wherein the substrate is a glass substrate.

30. The diffusing layer as claimed in claim 16 wherein the polymer is polycarbonate.

31. The diffusing layer as claimed in claim 6 wherein the substrate is a transparent substrate comprising a polymer.

32. The diffusing layer as claimed in claim 7 wherein the substrate is a transparent substrate comprising a polymer.

33. A light source comprising the diffusion layer as claimed in claim 1.

34. A backlighting system comprising the diffusion layer as claimed in claim 1.

35. A lamp comprising the diffusion layer as claimed in claim 1.
